(19) United States
(12) Patent Application Publication
(10) Pub. No.: US 2016/0243418 A1
(43) Pub. Date: Aug. 25, 2016

(54) GOLF GAME

(71) Applicant: Bowling Business Builders International, Inc., Marco Island, FL (US)

(72) Inventors: Bruce Edward DAVIS, Marco Island, FL (US); Stephanie Lynn DAVIS, Marco Island, FL (US); Darin Duane SPINDLER, Green Bay, WI (US); Andrew Joseph VASKO, Naples, FL (US)

(21) Appl. No.: 15/051,939

(22) Filed: Feb. 24, 2016

Related U.S. Application Data
(60) Provisional application No. 62/119,948, filed on Feb. 24, 2015.

(51) Int. Cl. A63B 67/02; G09B 19/00; B42D 15/00; A63B 71/06

(52) U.S. Cl. CPC A63B 67/02; A63B 71/0672; G09B 19/00; B42D 15/0006

(57) ABSTRACT

A method for effecting a game of golf is provided. The method includes providing a device for recording a score and providing rules for playing the game of golf. A device for keeping score during a golf game and a method of playing a golf game are also provided.

### CROSS-REFERENCE TO RELATED APPLICATIONS

This application claims the benefit of U.S. Provisional Application No. 62/119,948, filed on Feb. 24, 2015. The entire disclosure of the above application is incorporated herein by reference.

### FIELD

The present disclosure relates to methods for playing a golf game.

### BACKGROUND

This section provides background information related to the present disclosure which is not necessarily prior art.

Golf is one of the most popular recreational sports in the world. In the United States alone, nearly 25 million people play golf at least once a year. Additionally, golf equipment consumer purchases in the U.S. alone total about $3.7 billion annually, which does not include costs for apparel, costs to play golf, costs to utilize driving ranges, or costs for golf-related travel. However, many golfers have lowered their frequency of play or no longer play at all. Many of these people have not taken those actions as the result of losing their “love for golf” and/or the experience of getting out on a course for some friendly competition. Instead, other issues in life usually have come into play. The biggest issue is that the time required to complete a round of golf comes into conflict with family, work and/or other commitments. Additionally, the amount of playing time (and cost) required to “stay sharp” and consistently hit enough good shots to keep a round fun is a commitment that many cannot afford to make.

In recent years much of the “golf talk” in the media has trended toward bad news, such as continuing declines in participation, financial difficulties faced by course operators, course closings, equipment sales slumps and the like. The bad news in and of itself further feeds the difficulties the golf industry faces. Therefore, new games of golf that are quicker relative to a traditional round of golf and that allow participants to be available for other commitments are desirable.

### SUMMARY

This section provides a general summary of the disclosure, and is not a comprehensive disclosure of its full scope or all of its features.

The current disclosure provides a method for effecting a game of golf. The method includes providing a device for recording a score and providing rules for playing the game of golf.

The device includes a plurality of columns and a plurality of rows, wherein the plurality of rows and the plurality of columns intersect each other to define a grid having a plurality of cells. The first cell in each column identifies a heading for the column. As such, a first cell in a first column identifies a hole number, a first cell in a second column identifies posted par for a hole, a first cell in a third column identifies fairway points, a first cell in a fourth column identifies green in regulation points, a first cell in a fifth column identifies putting, the fifth column being divided into a plurality of sub-columns identifying putting points for specific numbers of putts, and a first cell in a sixth column identifies hole totals. The plurality of rows includes a row for each hole to be played for a predetermined number of holes and a row identifying a total score. The grid provides, in cells corresponding to each of the plurality of rows and columns identifying fairway points, green in regulation points, and putting points, point values for each of fairway points, green in regulation points, and putting points, respectively.

The rules include driving a plurality of drive balls towards a green on a hole on a golf course; determining which one of the plurality of drive balls has the best lie; and recording fairway point values on the device in a cell corresponding to a row for the hole being played and the third column identifying fairway points when the one drive ball having the best lie lies on a the hole's fairway or green. The rules also provide for hitting a plurality of approach balls toward the green from a region where the one drive ball having the best lie is located; determining which one of the plurality of approach balls has the best lie; and, when the one of the plurality of approach balls having the best lie is not on the holes green, repeating hitting a plurality of additional approach balls toward the green from a region where the one approach ball having the best lie is located and determining which one of the plurality of additional approach balls has the best lie until one of the additional approach ball having the best lie lies on the green. The rules then include recording green in regulation point values on the device in a cell corresponding to the row for the hole being played and the fourth column identifying green in regulation points when the one approach ball having the best lie lies on the hole's green in 2 strokes fewer than the hole's par designation. Next, the rules provide for putting the one approach ball having the best lie on the hole's green until the approach ball lands in the hole's hole; recording putting point values on the device in a cell corresponding to the row for the hole being played and a sub-column identifying the number of putts that were played to get the one approach ball to land in the hole's hole; and recording a hole total value on the device in a cell corresponding to the row for the hole being played and the sixth column identifying hole totals. The rules provide for repeating the previous rules for remaining additional holes corresponding to the predetermined number of holes to be played; and recording a total score value on the device in a cell corresponding to the row identifying a total score and the sixth column identifying hole totals, wherein the total score is a sum of hole total values for each of the holes played.

The current disclosure also provides a device for recording a score in a golf game. The device includes a plurality of columns and a plurality of rows, wherein the plurality of rows and the plurality of columns intersect each other to define a grid having a plurality of cells. The first cell in each column identifies a heading for the column. A first cell in a first column identifying a hole number, a first cell in a second column identifying posted par for a hole, a first cell in a third column identifying fairway points, a first cell in a fourth column identifying green in regulation points, a first cell in a fifth column identifying putting, the fifth column being divided into a plurality of sub-columns identifying putting points for specific numbers of putts, and a first cell in a sixth column identifying hole totals. The plurality of rows includes a row for each hole to be played for a predetermined number of holes and a row identifying a total score. The grid provides, in cells corresponding to each of the plurality of rows and columns identifying fairway points, green in regulation points, and putting points, point values for each of fairway points, green in regulation points, and putting points, respectively.

Also, the current disclosure provides a method of playing a golf game. The method includes driving a plurality of drive balls towards a green on a hole on a golf course; determining which one of the plurality of drive balls has the best lie; and recording fairway point values when the one drive ball having the best lie lies on the hole's fairway or green. The method also includes hitting a plurality of approach balls toward the green from a region where the one drive ball having the best lie is located; determining which one of the plurality of approach balls has the best lie; and, when the one approach ball having the best lie is not on the hole's green, repeating hitting a plurality of additional approach balls toward the green from a region where the one approach ball having the best lie is located and determining which one of the plurality of additional approach balls has the best lie until one of the additional approach balls having the best lie lies on the hole's green. The method includes recording green in regulation point values when the one approach ball having the best lie lies on the hole's green in 2 strokes fewer than the hole's par designation. The method further includes putting the one approach ball having the best lie on the hole's green until the approach ball lands in the hole's hole; recording a putting point value; and recording a hole total value. The method provides for repeating the previous rules for a predetermined number of holes; and recording a total score, wherein the total score value is a sum of hole total values for each of the holes played.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a method for effecting a game of golf;

FIG. 2 is a diagram of a device for recording golf scores;

FIG. 3 is a flow chart showing the rules for playing a golf game;

FIG. 4 is a diagram showing a scorecard having a device provided on one side and golf rules provided on a second opposing side;

FIG. 5 is a diagram showing an exemplary scoring device for a twosome;

FIG. 6 is a diagram showing an exemplary scoring device for a single player; and

FIG. 7 is a set of rules that describes how to play a golf game.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters.

In addition, disclosure of ranges includes disclosure of all values and further divided ranges within the entire range, including endpoints and sub-ranges given for the ranges. As referred to herein, ranges are, unless specified otherwise, inclusive of endpoints and include disclosure of all distinct values and further divided ranges within the entire range. Thus, for example, a range of “from A to B” or “from about A to about B” is inclusive of A and of B.

Example embodiments will now be described more fully with reference to the accompanying drawings.

A new golf game that is fun, time sensitive and competitive is provided. The golf game allows players to play the equivalent of 18 holes of golf action in approximately 90 minutes. The golf game has features that resemble an individual scramble over an existing 6 hole run with a unique scoring system. The golf game particularly appeals to golfers who have limited time to golf while standard golfing skills are employed. The game offers a unique scoring system that awards points for good shots. The golf game rewards points for good shots, which increase in value as the golf game progresses, which provides players with comeback opportunities. The golf game can be played by a single person, or by a plurality of players, such as, for example, twosomes, threesomes, and foursomes. The golf game is suitable for leagues, tournaments, outings, casual play, or other special events. In one six hole round, for example, a player hits 18 drives and at least 18 fairway and/or approach shots while putting out one ball on each green.

The golf game can be played by anyone, including, as a non-limiting example, those who enjoy golf, yet find it difficult to commit time to playing 18 holes of traditional golf due to personal, family, or occupational obligations. As noted above, the golf game provides golfers the benefit of 18 holes worth of golfing action in 90 minutes of time or less. The golf game provides unique, fun golfing competition; player vs. player golfing as twosomes, threesomes, foursomes, etc., and player vs. the world of the golf game golfers as scores are reported to and displayed through a section of a website directed to the golf game.

Non-limiting examples of attributes provided by the golf game include: golfers get multiple attempts to hit drives and fairway shots, golfers work to build their scores (and average score) because they can win bonus points each time they swing and because the high scores win matches, the golf game's escalating bonus point format allows for a player to catch up with his/her opponent(s) because bonus point values increase as the round moves from start to finish, outstanding shots or other accomplishments earn super bonus points, and the golf game administrator may provide an internet based platform for golfers to report their scores, establish an average, and earn rewards based on skill and/or frequency of play.

Courses or hole layouts for playing the golf game can be located by contacting individual traditional golf courses and inquiring about the golf game or by going to an administrator's website and following the prompts. It is at this same website that golfers can register as a golfer of the golf game. The courses can be traditional courses for playing a traditional round of golf or courses designed specifically for the golf game. Fees for playing the golf game can be paid at a participating golf course; however, in some embodiments, fees are paid exclusively through the website. When fees are paid exclusively through the website, participating golf courses will not accept direct payment at the course for the golf game. When a golfer chooses a golf course, a time to play and pays the fees, the golfer will be provided a “proof of purchase” to present to the course as greens fees. The website and participating courses can accommodate individual payments for those golfers playing in groups, or individually, such as, for example, during a “practice round.” In case of weather or other delay issues, management of the golf course will attend to any rescheduling. In various embodiments, participating golf courses are hosted on a website that displays conditions, such as tee times and pricings. Tee times can be confirmed to both courses and golfers by a third party administrator who collects green fees and pays courses after deducting an administrative fee.

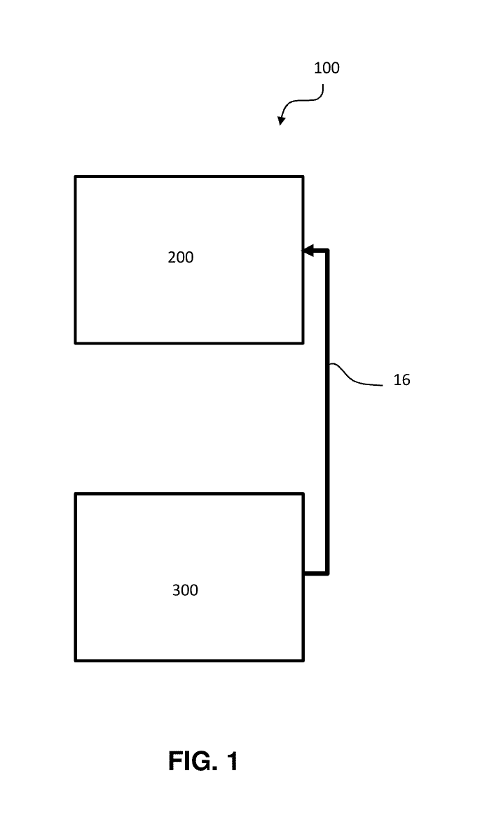

With reference to FIG. 1, the current disclosure provides a method 100 for effecting a game of golf. Effecting a game of golf includes providing a device 200 for recording a score; and providing rules or a set of rules 300 for playing the game of golf. As will be described in more detail below, the rules 300 require a feedback loop 16 herein scores and/or other information is recorded on the device 200. Furthermore, the current disclosure provides the device 200 and methods for playing a golf game as dictated by the rules 300.

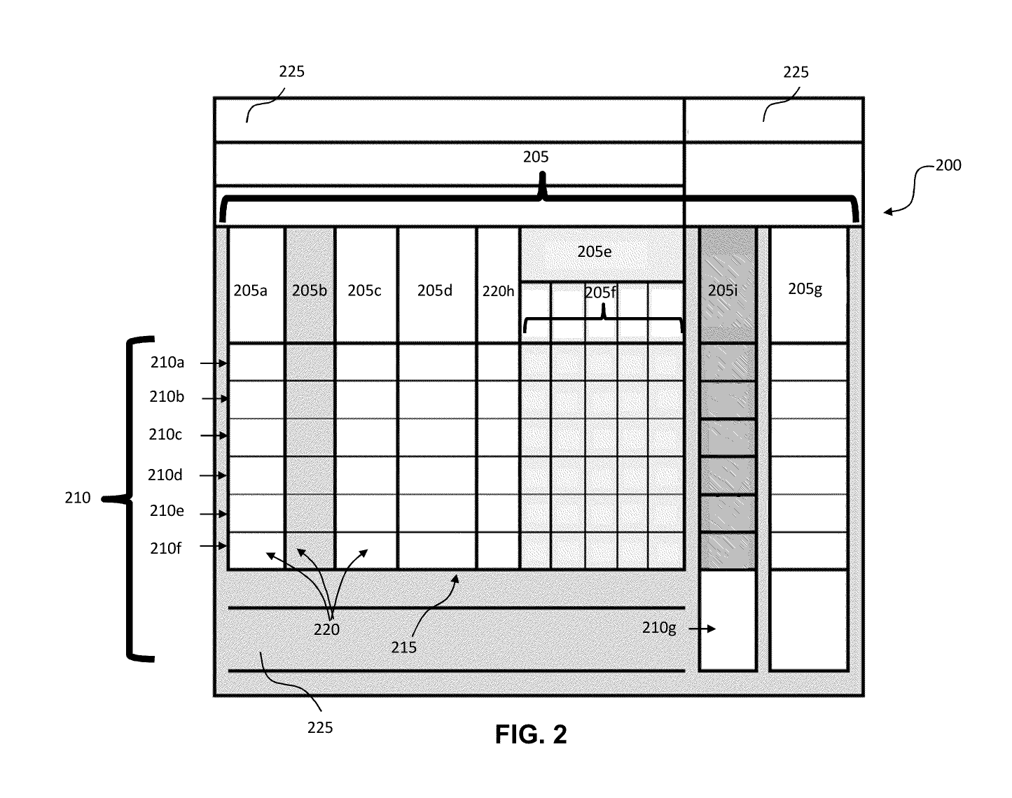

The device 200 of FIG. 1 is shown in greater detail in FIG. 2. The device 200 includes a plurality of columns 205 and a plurality of rows 210, wherein the plurality of column 205 and the plurality of rows 210 intersect each other to define at least one grid 215 having a plurality of cells 220. A first cell in each column identifies a heading for the column. For example, a first cell in a first column 205a identifies a hole number, a first cell in a second column 205b identifies posted par for a hole, a first cell in a third column 205c identifies fairway points, a first cell in a fourth column 205d identifies green in regulation points, a first cell in a fifth column 205e identifies putting, the fifth column being divided into a plurality of sub-columns 205f identifying putting points for specific numbers of putts, and a first cell in a sixth column 205g identifies hole totals. For example, different point values may apply for 0 putts, 1 putt, 2 putts, 3 putts, 4 putts, 5 putts and so on until a predetermined maximum number of putts is reached.

The plurality of rows 210 includes a row for each hole to be played 210a-210f for a predetermined number of holes and a row identifying a total score 210g. In some embodiments, such as in FIG. 2, the device 200 includes 6 rows 210a-210f, representing one row each for 6 holes to be played. Nonetheless, it is understood that any number of holes can be played in a round of the golf game, such as from 1 hole to 18 holes or more. The grid 215 provides, in cells 220 corresponding to each of the plurality of rows 210a-210f and columns identifying fairway points 205c, green in regulation points 205d, and putting points 205f, point values for each of fairway points, green in regulation points, and putting points, respectively. As discussed above, point values increase as the golf game progresses from the first to last hole, here from the first hole 210a to the sixth hole 210f. In one embodiment, the grid 215 includes, under the first cell of the third column 205c identifying fairway points, fairway point values of: 3 for rows 1 and 2 (210a and 210b); 6 for rows 3 and 4 (210c and 210d); and 9 for rows 5 and 6 (210e and 210f). In this embodiment, the grid 215 also includes, under the first cell of the fourth column 205d identifying green in regulation points, green in regulation point values of: 4 for rows 1 and 2 (210a and 210b); 7 for rows 3 and 4 (210c and 210d); and 10 for rows 5 and 6 (210d and 210f). In this embodiment, the grid 215 further includes, under the plurality of sub-columns 205f identifying putting points for specific numbers of putts, putting point values of: 6 for no putts, 3 for 1 putt, −1 for 3 putts, −2 for 4 putts, and −3 for 5 putts for rows 1 and 2 (210a and 210b); 12 for no putts, 6 for 1 putt, −1 for 3 putts, −2 for 4 putts, and −3 for 5 putts for rows 3 and 4 (210c and 210d); and 18 for no putts, 9 for 1 putt, −1 for 3 putts, −2 for 4 putts, and −3 for 5 putts for rows 5 and 6 (210e and 210f).

As shown in FIG. 2, in some embodiments, the device also includes a first cell in a seventh column 205h identifying that all the plurality of drive balls, approach balls, or additional approach balls land out of bounds or are lost or that a score above par was obtained, and the grid 215 further providing, in cells 220 corresponding to each of the plurality of rows 210a-210f and the seventh column 205h, negative point values for all the plurality of drive balls, approach balls, or additional approach balls landing out of bounds or being lost or for obtaining a score above par, and/or a first cell in an eighth column 205i identifying super points, and the grid 215 further providing, cells corresponding to each of the plurality of rows 210a-210f and the eighth column 205i, 4 super point values corresponding to 4 super scores, wherein the 4 super scores are a birdie, eagle, double eagle, and hole-in-one. In one embodiment, the 4 super point values for a birdie, eagle, double eagle, and hole-in-one are 3, 6, 9, and 12, respectively.

In various embodiments, the device 200 further includes information cells 225 for recording information about at least one of at least one player or a golf course. In yet other embodiments, the device 200 is a scorecard. The device 200 may include blank cells 220 that should be filled in by a player. For example, a player may have to record hole numbers and par designations for each hole on the device 200. A player may also record identification information on the device 200, such as information that identifies the player and information that identifies the course.

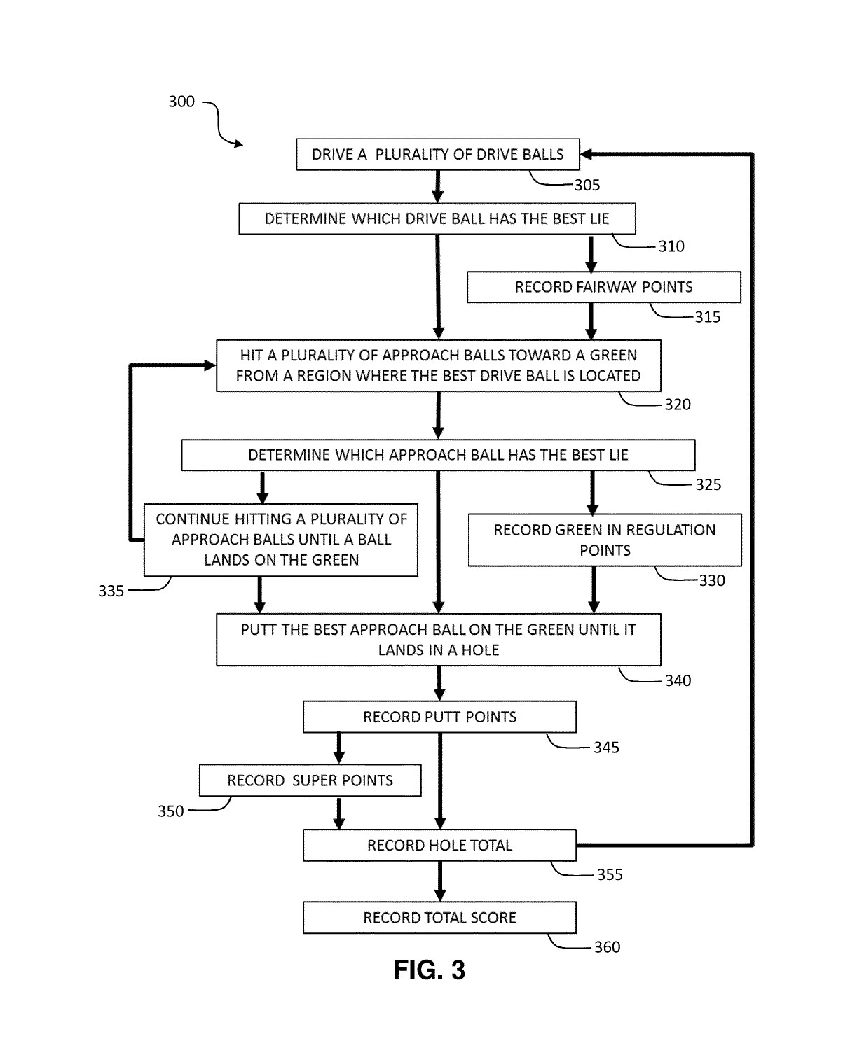

The rules or a set of rules 300 for playing the game of golf of FIG. 1 is shown in greater detail in FIG. 3. However, the description of the rules will also refer to the device 200 of FIG. 2. In particular, the rules 300 provide a method for playing a golf game. In block 305, the rules 300 include driving a plurality of drive balls towards a green on a hole on a golf course. The drive balls are hit from behind markers placed in a tee box by, for example, course management or a player. The number of drive balls is not limiting and can be, for example, 2 drive balls to 10 drive balls or more. However, in one embodiment, the rules 300 provide for consecutively driving 3 drive balls. In order to increase the speed of play, some embodiments provide that practice swings are permitted only prior to the first drive, i.e., no practice swings are permitted after the first drive ball is hit. Also to increase the speed of play, the rules may provide that all of the plurality of drive balls be teed up prior to driving the first drive ball. When multiple players are playing the golf game, a first player drives all of the first player's plurality of drive balls followed by a second player driving all of the second player's drive balls, and so on.

In block 310, the rules 300 provide determining which one of the plurality of drive balls has the best lie. After it is determined which drive ball has the best lie, the remaining drive balls may be picked up. Then, in block 320 the rules 300 provide recording fairway point values on the device 200 in a cell 220 corresponding to a row for the hole being played 210a-210f and the third column 205c identifying fairway points when the one drive ball having the best lie lies on the hole's fairway or green. Recording fairway point values may include either writing in a point value or marking a point value already provided on the device 200, such as, for example, with a check mark, circle, or other identifying mark. In some embodiments, a drive ball is determined to have landed on a fairway when the drive ball is stopped and the entire ball is on the fairway. In other embodiments, a drive ball is determined to have landed on a fairway when the drive ball is stopped and any part of the drive ball touches, i.e., is in direct contact with, at least one blade of fairway grass. Similarly, a drive ball is determined to have landed on the hole's green when the drive ball is stopped and either the entire drive ball is on the hole's green or any part of the drive ball touches, i.e., is in direct contact with, at least one blade of grass from the green, depending on the rules in place on the course. In various embodiments, a fringe around a green may or may not be considered part of the hole's green. Whether a fringe is considered part of the hole's green is determined by the players prior to beginning play, by course management, by an administrator of the golf game, or by an administrator of a website for the golf game.

Referring back to block 310, it is understood that determining which drive ball has the best lie may include determining that a drive ball that is not on the fairway has the best lie even though another drive ball is on the fairway. Although no fairway points would be awarded to the golfer, the ball with the best lie may be in better position to reach the green on the subsequent shot, which will result in green in regulation points, which are higher than fairway points, as discussed in more detail below.

It is understood that some par 3 holes have a designated fairway and some par 3 holes do not have a designated fairway. Therefore, on a par 3 hole, a drive ball having the best lie that is not on the green may only earn fairway points if a designated fairway exists for the par 3 hole and the drive ball having the best lie is determined to have landed on the designated fairway.

Next, block 320 of the rules 300 provides hitting a plurality of approach balls toward the hole's green from a region where the one drive ball having the best lie is located. In particular, the region where the one drive ball having the best lie located is defined by a predetermined distance or radius from the position of the drive ball with the best lie. The predetermined distance or radius is not limiting and can be from 6 inches to 24 inches or further. In one embodiment, the region is equal to or less than 12 inches from the position of the drive ball having the best lie. When a player's drive ball is behind a tree or other obstacle, or in a hazard bunker, the obstacle must stay between the player and the hole, but the region where the one drive ball having the best lie is located may help improve the subsequent shot. As used herein, an “approach ball” differs from a “drive ball” only by the stroke hitting the golf ball. The golf balls are physically the same, other than perhaps differences provided by different brands.

The number of approach balls hit is not limiting and can be, for example, 2 approach balls to 10 approach balls or more. In some embodiments, the number of approach balls hit is the same as the number of drive balls hit. In one embodiment, the rules 300 provide for consecutively hitting 3 approach balls. In order to increase the speed of play, some embodiments provide that practice swings are permitted only prior to hitting the first approach ball, i.e., no practice swings are permitted after the first approach ball is hit. In other embodiments, no practice swings are permitted after driving the first drive ball, as discussed above. Therefore, in such embodiments no practice swings are permitted at all for the rest of play. Also to increase the speed of play, the rules may provide that all of the plurality of approach balls be placed down or dropped prior to hitting the first approach ball. When multiple players are playing the golf game, a first player hits all of the first player's plurality of approach balls followed by a second player hitting all of the second player's approach balls, and so on.

In block 325, the rules 300 provide determining which one of the plurality of approach balls has the best lie. After it is determined which approach ball has the best lie, the remaining approach balls may be picked up. Then, in block 330 the rules 300 provide recording fairway point values on the device 200 in a cell 220 corresponding to a row for the hole being played 210a-210f and the fourth column 205d identifying green in regulation points when the one approach ball having the best lie lies on a the hole's green. Recording green in regulation point values may include either writing in a point value or marking a point value already provided on the device 200, such as, for example, with a check mark, circle, or other identifying mark. Methods for determining whether a ball lies on a green are discussed above. However, it is understood that a ball may only be considered as being on a green if the subsequent shot is a putt. If a drive ball reaches a green on a par 3, par 4, or par 5 hole, both fairway points and green in regulation points are recorded on the device 200.

As shown in block 335, the rules 300 provide hitting an additional plurality of approach balls from a region where the one approach ball having the best lie is located towards the green and in block 325 determining which approach ball has the best lie until the one approach ball determined to have the best lie is located on the hole's green. In particular, and similar to determining the region where the one drive ball having the best lie is located, the region where the one approach ball having the best lie is located is defined by a predetermined distance or radius from the position of the approach ball with the best lie. The predetermined distance or radius is not limiting and can be from 6 inches to 24 inches or further. In one embodiment, the region is equal to or less than 12 inches from the position of the approach ball having the best lie. When a player is behind a tree or other obstacle, or in a hazard bunker, the obstacle must stay between the player and the hole, but the region where the one approach ball having the best lie is located may help improve the subsequent shot. In block 330, the rules provide recording green in regulation point values on the device 200 in a cell 220 corresponding to the row for the hole being played 210a-210f and the fourth column 205d identifying green in regulation points when the one approach ball having the best lie lies on the hole's green in 2 strokes fewer than the hole's par designation.

As discussed above, in some embodiments the device 200 includes a first cell in a seventh column 205h identifying that all the plurality of drive balls, approach balls, or additional approach balls land out of bounds or are lost or that a score above par was obtained, and the grid 215 further providing, in cells 220 corresponding to each of the plurality of rows 210a-210f and the seventh column 205h, negative point values for all the plurality of drive balls, approach balls, or additional approach balls landing out of bounds or being lost or for obtaining a score above par. Should a player hit all of the player's plurality of drive balls or approach balls out of bounds, or they are all lost, negative points are recorded on the device 200 in a cell 220 corresponding to the hole being played 210a-210f and the seventh column 205h. The player then goes to the “out of bounds/line of flight” of the last ball to drop a next plurality of approach balls for a next shot. A location for dropping the next plurality of approach balls is agreed upon between plays with the non-hitting players having a “majority say.” No green in regulation points may be awarded for the player for the hole. In various embodiments, because searching for lost balls takes time, a ball is deemed lost when it is not identified after a predetermined amount of time, such as, for example, from about 30 seconds to about 5 minutes. In some embodiments, the ball is determined to be lost if it is not identified after 60 seconds of searching.

In block 340, the rules 300 include putting the one approach ball having the best lie on the hole's green until the approach ball lands in the hole's hole. No additional balls are dropped and played. Once a player starts to putt, the player continues to putt until the ball is in the hole without giving way to other players. In some embodiments, a player is penalized a predetermined amount of points for each putt over a predetermined number of putts until a maximum number of putts is reached. As described above, in some embodiments there is a 1 point penalty for each putt over 2 with a 5 putt maximum. Then, in block 345 the rules 300 include recording putting point values on the device 200 in a cell 220 corresponding to the row for the hole being played 210a-210f and a sub-column 205f identifying the number of putts that were played to get the one approach ball to land in the hole's hole. After a player putts the ball in the hole, a subsequent player may begin putting.

In block 350, the rules 300 include recording super points on the device 200 in a cell 220 corresponding to the row for the hole being played 210a-210f and the column 205i identifying super points. Super points apply for a score of a birdie, eagle, double eagle, and hole-in-one.

In block 355, the rules 300 include recording a hole total value on the device 200 in a cell 220 corresponding to the row for the hole being played 210a-210f and the sixth column 205g identifying hole totals. The hole total is the net sum of values recorded, positive and negative, for fairway points, green in regulation points, out of bounds or score over par points, putting points, and super points. The rules then provide for repeating the previous rules for remaining additional holes corresponding to the predetermined number of holes to be played. After the final hole is played, in block 360 the rules 300 provide for recording a total score value on the device 200 in a cell 220 corresponding to the row identifying a total score 210g and the sixth column 205g identifying hole totals, wherein the total score is a sum of hole total values for each of the holes played. The player having the highest total score is determined to be the winner.

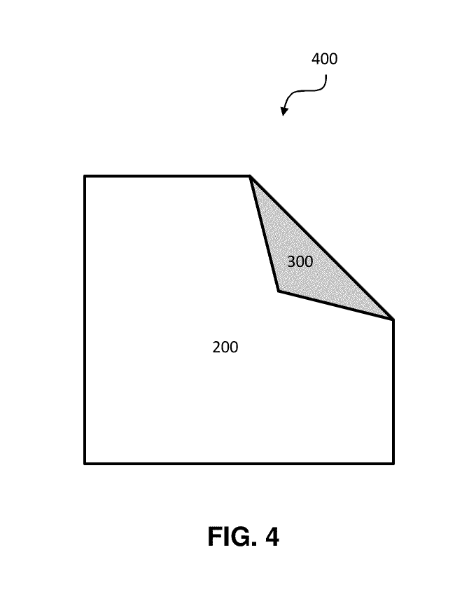

In some embodiments, the method 100 for effecting a game of golf depicted in FIG. 1 includes simultaneously providing a device 200 for recording a score; and providing rules or a set of rules 300 for playing the game of golf. For example, the rules or set of rules 300 may be provided on the device 200 for recording a score. FIG. 4 shows a scorecard 400 having the device 200 provided on one side and the rules or set of rules 300 provided on a second opposing side. By providing the scorecard 400 to a player, the device 200 and rules 300 are provided to the player simultaneously. Notwithstanding, in other embodiments, the device 200 and set of rules 300 are provided as separate articles, which can be provided to a player simultaneously or at different times. In some embodiments, the device 200 and rules 300 may be obtained from a website.

As described above, after playing a golf game by the rules 300, the total score may be recorded on a website maintained by an administrator. The website maintains scores for individual golfers and calculates averages. Golfers may use the website to pay fees and register for tournaments. Therefore, the administrator of the website or a golf course may effect a game of golf according to the current disclosure.

Embodiments of the present golf game are further illustrated through the following non-limiting examples.

### EXAMPLE 1

A golf game to be played over 6 holes is provided. The golf game abides by the following rules and utilizes the following devices. It is understood that the following is an exemplary set of rules and alternative rules or scores as indicated by alternative devices are contemplated.

Teeing Off

Each golfer has 3 consecutive attempts (drives) at each of the 6 holes played. Drives will be hit from behind markers placed at tee boxes for each hole by the course management. No practice swings are permitted after the first drive is hit and, for faster play, the players may tee up 3 balls prior to hitting their first drive. One player drives all 3 of his/her balls followed by their playing partner driving all 3 of his/her balls.

After hitting 3 drives, the player selects the ball he/she wants to play and picks up the other 2 balls if they are not lost. When the best ball selected is lying in the fairway, the shot will result in Fairway Bonus Points. The ball must be at least touching some fairway grass to be “lying in the fairway.” Fairway Bonus Points vary and increase in value as the round progresses. Moreover, the Fairway Bonus Points are provided on a scoring device. Therefore, when Fairway Bonus Points are awarded, the points are recorded on the scoring device. Fairway Bonus Points are:
Holes 1 &2, fairway lie=3 points;
Holes 3&4, fairway lie=6 points; and
Holes 5&6, fairway lie=9 points.

For purposes of differentiation each player may use colored golf balls (not white) that are different from colors being used by other players/partners. Avoiding white balls can help keep the golf game players from checking out balls hit nearby from golfers playing a traditional round of golf on the course.

Approach to the Green

The golfer chooses the best ball lie from the 3 drives, drops 2 additional balls within one foot of the best ball lie and hits 3 shots from that location toward the green. If the player is behind a tree or in a hazard bunker, the obstacle must stay between the player and the hole, but the one foot placement area may help improve one or more of the next shots. This best of 3 shots (best ball) format continues for a player until at least one of his/her balls comes to rest on the green.

To earn Green In Regulation (GIR) Bonus Points, one of the players approach shots must be touching a part of the putting surface in 2 strokes less than posted par for that hole. The only exception is when the golfer's tee shot reaches the green on a par 3, par 4, or par 5, wherein the bonus points for both drive (Fairway Bonus Points) and green in regulation (GIR) will be awarded. For example: Hole 3, Par 3; the golfer's tee shot reaches the hole's green, the bonus points earned are 6 Fairway Bonus Points for the drive, plus 7 GIR Bonus Points for reaching the green in regulation. GIR Bonus Points vary and increase as the round progresses. Moreover, the GIR Bonus Points are provided on the scoring device. Therefore, when GIR Bonus Points are awarded, the points are recorded on the scoring device. GIR Bonus Points are:
Holes 1 &2, green in regulation=4 points;
Holes 3&4, green in regulation=7 points; and
Holes 5&6, green in regulation=10 points.

LOST BALLS

Searching for lost or hidden balls wastes time and to a typical golfer playing the golf game, time is more important than the cost of a used ball. A ball is deemed lost when it is not identified by a player after a 60 second cursory search. Lost balls are left behind for a conventional golfer to find.

Should a player have the misfortune of hitting 3 drives or 3 fairway shots that all go out of bounds or are lost, the player will go to the “out of bounds/last sight line” of the 3rd shot to drop 3 balls for his/her next shot (that spot will be agreed upon between the player and his/her playing partner(s) with the partner(s) having the “majority say”.

Putting

Once a player has one or more approach shots on a green (at least touching a portion of a green), the player chooses which ball to play and that ball will be the only ball played to finish the hole. Therefore, the player does not drop and putt additional balls on a green. Once a player starts to putt, he/she continues to putt until the ball is in the hole without giving way to playing partners. There are no “gimmies” in the golf game. All putts are counted.

Regardless of how many shots it takes to reach the green, a player can still earn bonus points if he/she one putts, or chips a ball in the hole's hole from off the green (see Super Bonus Points below). 1 Putt Bonus Points vary and increase in value as the round progresses. Moreover, the 1 Putt Bonus Points are provided on the scoring device. Therefore, when 1 Putt Bonus Points are awarded, the points are recorded on the scoring device. 1 Putt Bonus Points are:
Holes 1 &2, 1 putt bonus=3 points;
Holes 3&4, 1 putt bonus=6 points; and
Holes 5&6, 1 putt bonus=9 points.

A player is penalized 1 point (lost or negative points) for each putt over 2 putts. For example, if a player 3 putts, the player will lose 1 point. For a 4 putt hole the player will lose 2 points. For a 5 putt and over hole, the player loses 3 points (the maximum negative putting points for a hole).

Super Bonus Points

A “Big Bang” is accomplished when a player is fortunate enough to “chip in” or sinks his/her approach shot to the green. In such cases, both the bonus points for GIR and zero putts will be earned. GIR and Big Bang Bonus Points vary and increase as the round progresses. Moreover, the Big Bang Bonus Points are provided on the scoring device under a column with a heading of “Putting Bonus or Penalty Points” and under a putting sub-column for “no putt” or “0 putts.” Therefore, when Big Bang Bonus Points are awarded, the points are recorded on the scoring device. Big Bang Bonus Points are:
Holes 1 &2, zero putt bonus=6 points;
Holes 3&4, zero putt bonus=12 points; and
Holes 5&6, zero putt bonus=18 points.

A Little Bird is accomplished for a best ball birdie on any hole and results in 3 Super Bonus Points. A Big Bird is accomplished for a best ball eagle on any hole and results in 6 Super Bonus Points. A Rare Bird is accomplished for a best ball double eagle on any hole and results in 9 Super Bonus Points. A Big Boom is accomplished for a best ball hole-in-one on any hole and results in 12 Super Bonus Points. Super Bonus Points for a Little Bird, Big Bird, Rare Bird, and Big Boom are provided on the device. Therefore, when Super Bonus Points are awarded, the points are recorded on the scoring device.

For example, if hole 3 is designated par 4 and a golfer holes out his/her 3^{rd} shot from beyond the green, the golfer will earn 12 Big Bang Bonus Points for 0 putts and 3 Super Bonus Points for a Little Bird. All of these points are recorded on the device. If hole 5 is designated par 5 and a golfer holes out his/her 3^{rd} shot from beyond the green, the golfer will earn 10 GIR Bonus Points, 18 Big Bang Bonus Points for 0 putts, and 6 Super Bonus Points for a Big Bird (traditional eagle). All of these points are recorded on the device.

Pace of Play

Time is valuable to most players and, while it is not desired that golfers rush their game, it is generally agreed that an average of 15 minutes per hole is an appropriate pace. This pace allows for twosomes to play in conjunction with others playing conventional rounds at the course.

Scorekeeping

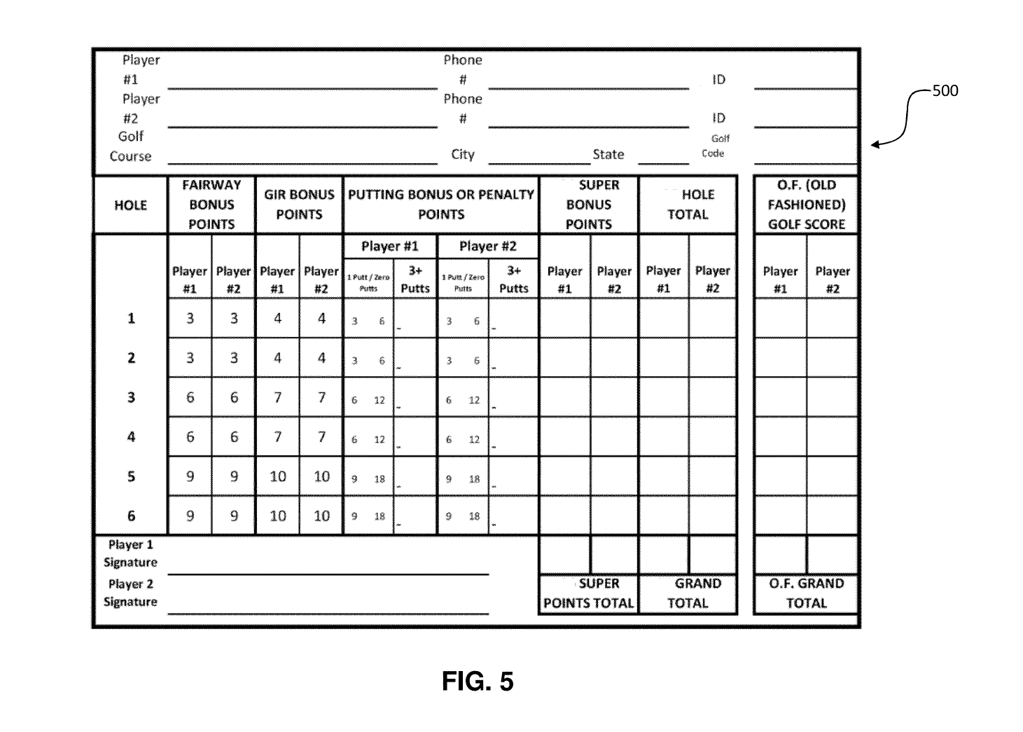

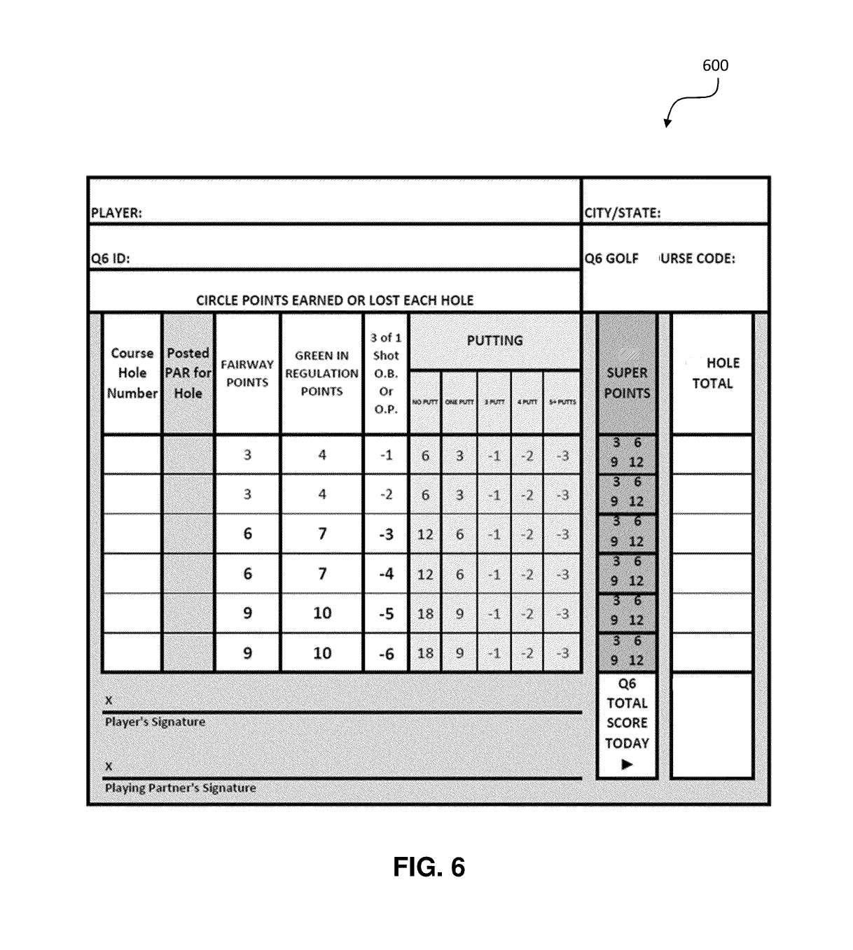

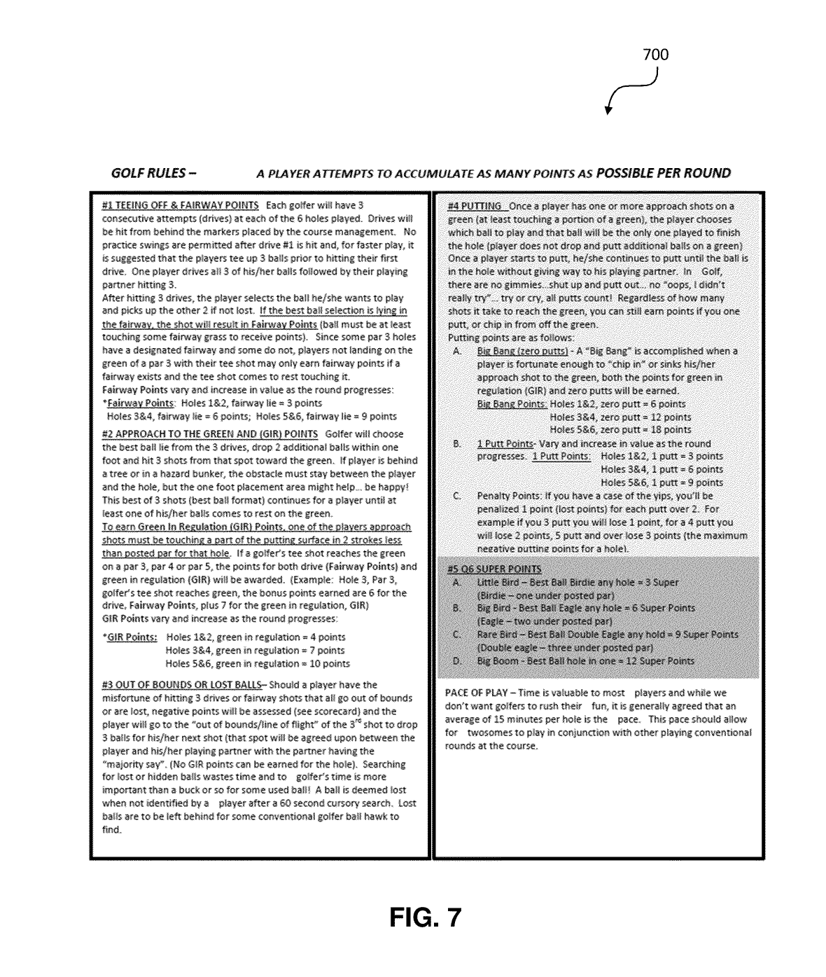

Accurate and honest score recording are critical for participation in the golf game. Golfers build an average that is used as a prerequisite for entry in leagues, tournaments, and/or events and without proper recording of scores, such events and tournaments could lack credibility and true competition. There is either one scoring device for each twosome, threesome, etc. or one scoring device for each player. FIG. 5 shows an exemplary scoring device 500 for a twosome. FIG. 6 shows an exemplary scoring device 600 for a single player. The scoring devices 500, 600 may be scorecards. FIG. 7 shows a set of rules 700 that may be displayed on either scoring device 500 for a twosome or scoring device 600 for a single player. Alternatively, the set of rules 700 may be provided separately from the scoring devices 500, 600. Points earned or lost are to be agreed upon and recorded at the completion of each hole on the scoring device 500, 600, prior to teeing off on the next hole.

Golf Game Terminology

TEE OFF LOCATION: Area designated by tee markers within a tee box where players tee up 3 balls to start a hole. All golfers use the same tee off locations except during special events, leagues and tournaments.

FAIRWAY: Closely mown area between a tee box and green. To earn Fairway Bonus Points from at least 1 of 3 shots, a ball must be on or touching the fairway.

GREEN: Smooth area of short grass located at the end of the fairway where the flagstick and hole are placed. To earn GIR Bonus Points from at least one of 3 drive or approach shots, a ball must be on or touching the green.

OUT OF BOUNDS: Areas outside the golf course or hole layout from which play is not allowed. Out of bounds areas are often identified by a white stake, line, fence, or signage.

UNPLAYABLE HAZARD: Pond, creek, or restricted area in which the ball is not playable or play is not allowed.

GREEN IN REGULATION (GIR): Any part of the ball is touching the putting surface after the number of strokes taken is 2 fewer than the par designation for that hole.

BIG BANG: A bonus accomplished when a player chips in or sinks his/her approach shot to the green.

SUPER BONUS POINTS: Extra points earned when accomplishing select conventional golf scores, i.e., birdie, eagle, double eagle, or hole-in-one.

LITTLE BIRD: A bonus accomplished when a player earns a conventional birdie (1 shot under posted par).

BIG BIRD: A bonus accomplished when a player earns a conventional eagle (2 shots under posted par).

RARE BIRD: A bonus accomplished when a player earns a conventional double eagle (3 shots under posted par).

BIG BOOM: A bonus accomplished when a player earns a conventional hole-in-one (a shot that enters the hole from the tee with no intervening shots).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for effecting a game of golf, the method comprising:
providing a device for recording a score, the device comprising:
a plurality of columns and a plurality of rows, wherein the plurality of rows and the plurality of columns intersect each other to define a grid having a plurality of cells,
wherein a first cell in each column identifies a heading for the column, a first cell in a first column identifying a hole number, a first cell in a second column identifying posted par for a hole, a first cell in a third column identifying fairway points, a first cell in a fourth column identifying green in regulation points, a first cell in a fifth column identifying putting, the fifth column being divided into a plurality of sub-columns identifying putting points for specific numbers of putts, and a first cell in a sixth column identifying hole totals,
wherein the plurality of rows includes a row for each hole to be played for a predetermined number of holes and a row identifying a total score, and
wherein the grid provides, in cells corresponding to each of the plurality of rows and columns identifying fairway points, green in regulation points, and putting points, point values for each of fairway points, green in regulation points, and putting points, respectively; and
providing rules for playing the game of golf, the rules comprising:
driving a plurality of drive balls towards a green on a hole on a golf course;
determining which one of the plurality of drive balls has the best lie;
recording fairway point values on the device in a cell corresponding to a row for the hole being played and the third column identifying fairway points when the one drive ball having the best lie lies on the hole's fairway or green;
hitting a plurality of approach balls toward the green from a region where the one drive ball having the best lie is located;
determining which one of the plurality of approach balls has the best lie;
when the one of the plurality of approach balls having the best lie is not on the hole's green, repeating hitting a plurality of additional approach balls toward the green from a region where the one approach ball having the best lie is located and determining which one of the plurality of additional approach balls has the best lie until one of the additional approach balls lies on the green;
recording green in regulation point values on the device in a cell corresponding to the row for the hole being played and the fourth column identifying green in regulation points when the one approach ball having the best lie lies on the hole's green in 2 strokes fewer than a par designation for the hole;
putting the one approach ball having the best lie on the hole's green until the one approach ball lands in the hole's hole;
recording putting point values on the device in a cell corresponding to the row for the hole being played and a sub-column identifying the number of putts that were played to get the one approach ball to land in the hole's hole;
recording a hole total value on the device in a cell corresponding to the row for the hole being played and the sixth column identifying hole totals;
repeating the previous rules for remaining additional holes corresponding the predetermined number of holes to be played; and
recording a total score value on the device in a cell corresponding to the row identifying a total score and the sixth column identifying hole totals, wherein the total score is a sum of hole total values for each of the holes played.

2. The method according to claim 1, wherein the rules further include;
recording course hole numbers in each cell corresponding to rows for the holes being played and be third blank cell in a row corresponding to a hole being played and the first column identifying a hole number.

3. The method according to claim 1, wherein the grid further provides par designations in each cell corresponding to rows for the holes being played and the second column identifying posted par for a hole.

4. The method according to claim 1, wherein driving a plurality of balls comprises consecutively driving 3 drive balls and hitting a plurality of approach balls comprises consecutively hitting 3 approach balls.

5. The method according to claim 1, wherein recording fairway point values, recording green in regulation point values, and recording putting point values on the device comprises a fairway point value, recording green in regulation point value, or recording putting point value within a cell on the grid.

6. The method according to claim 1, wherein the device further comprises:
a first cell in a seventh column identifying that all the plurality of drive balls, approach balls, or additional approach balls land out of bounds or are lost; and the grid further provides, in cells for each of the plurality of rows, negative point values for all the plurality of drive balls, approach balls, or additional approach balls landing out of bounds or being lost, and
wherein the rules further include:
recording out of bounds or lost ball negative point values on the device in a cell corresponding to the row for the hole being played and the seventh column identifying that all the plurality of drive balls, approach balls, or additional approach balls land out of bounds or are lost.

7. The method according to claim 1, wherein the device further comprises:
a first cell in a seventh column identifying super points; and the grid further providing, for each of the plurality of rows, a cell including 4 super point values, and
wherein the rules further include:
recording a super point value on the device in a cell corresponding to the row for the hole being played and the seventh column identifying super points when 1 of 4 super scores for a hole is obtained, wherein the 4 super scores are a birdie, eagle, double eagle, and hole-in-one.

8. The method according to claim 7, wherein the super point values for the super scores are 3, 6, 9, 12, for a bride, eagle, double eagle, and hole-in-one, respectively.

9. The method according to claim 1, wherein the device comprises 1 row for each of 6 holes to be played.

10. The method according to claim 9, wherein the grid includes, under the first cell of the third column identifying fairway points, fairway point values of: 3 for rows 1 and 2; 6 for rows 3 and 4; and 9 for rows 5 and 6.

11. The method according to claim 9, wherein the grid includes, under the first cell of the fourth column identifying green in regulation points, green in regulation point values of: 4 for rows 1 and 2; 7 for rows 3 and 4; and 10 for rows 5 and 6.

12. The method according to claim 9, wherein the grid includes, under the plurality of sub-columns identifying putting points for specific numbers of putts, putting point values of: 6 for no putts, 3 for 1 putt, −1 for 3 putts, −2 for 4 putts, and −3 for 5 puts for rows 1 and 2; 12 for no putts, 6 for 1 putt, −1 for 3 putts, −2 for 4 putts, and −3 for 5 puts for rows 3 and 4; and 18 for no putts, 9 for 1 putt, −1 for 3 putts, −2 for 4 putts, and −3 for 5 puts for rows 5 and 6.

13. The method according to claim 1, wherein the device further includes information cells for recording information about at least one of at least one player or a golf course.

14. The method according to claim 1, wherein the rules further provide that when a plurality of players are playing, each golfer drives, hits or putts all of plurality of balls for a given shot prior to a subsequent player.

15. A device for recording a score in a golf game, the device comprising:
a plurality of columns and a plurality of rows, wherein the plurality of rows and the plurality of columns intersect each other to define a grid having a plurality of cells,
wherein a first cell in each column identifies a heading for the column, a first cell in a first column identifying a hole number, a first cell in a second column identifying posted par for a hole, a first cell in a third column identifying fairway points, a first cell in a fourth column identifying green in regulation points, a first cell in a fifth column identifying putting, the fifth column being divided into a plurality of sub-columns identifying putting points for specific numbers of putts, and a first cell in a sixth column identifying hole totals,
wherein the plurality of rows includes a row for each hole to be played for a predetermined number of holes and a row identifying a total score, and
wherein the grid provides, in cells corresponding to each of the plurality of rows and columns identifying fairway points, green in regulation points, and putting points, point values for each of fairway points, green in regulation points, and putting points, respectively.

16. The device according to claim 15, further comprising:
a first cell in a seventh column identifying that all the plurality of drive balls, approach balls, or additional approach balls land out of bounds or are lost, and the grid further providing, in cells corresponding to each of the plurality of rows and the seventh column, negative point values for all the plurality of drive balls, approach balls, or additional approach balls landing out of bounds or being lost; and
a first cell in an eighth column identifying super points, and the grid further providing, for each of the plurality of rows, a cells corresponding to each of the plurality of rows and the eighth column, 4 super point values corresponding to 4 super scores for a birdie, eagle, double eagle, and hole-in-one, respectively.

17. The device according to claim 15, wherein the device comprises 1 row for each of 6 holes to be played.

18. The device according to claim 15, wherein the device is a scorecard.

19. A method of playing a golf game, the method comprising:
driving a plurality of drive balls towards a green on a hole on a golf course;
determining which one of the plurality of drive balls has the best lie;
recording fairway point values when the one drive ball having the best lie lies on a the hole's fairway or green;
hitting a plurality of approach balls toward the green from a region where the one drive ball having the best lie is located;
determining which one of the plurality of approach balls has the best lie;
when the one approach ball having the best lie is not on the hole's green, repeating hitting a plurality of additional approach balls toward the green from a region where the one approach ball having the best lie is located and determining which one of the plurality of additional approach balls has the best lie until one additional approach ball having the best lie lies on the hole's green;
recording green in regulation point values when the one approach ball having the best lie lies on the hole's green in 2 strokes fewer than a par designation for the hole;
putting the one approach ball having the best lie on the hole's green until the one approach ball lands in the hole's hole;
recording a putting point value;
recording a hole total value;
repeating the previous rules for a predetermined number of holes; and
recording a total score value, wherein the total score value is a sum of hole total values for each of the holes played.

20. The method according to claim 19, wherein the golf game is played by a plurality of players and the player with the highest total score is determined to win the golf game.
